(19) United States
(12) Patent Application Publication
(10) Pub. No.: US 2026/0302565 A1
(43) Pub. Date: Oct. 1, 2026

(54) SOLID-STATE BATTERY AND METHOD OF MANUFACTURING SOLID-STATE BATTERY

(71) Applicant: HONDA MOTOR CO., LTD., Tokyo (JP)

(72) Inventor: Akihiro TAGUCHI, Saitama (JP)

(21) Appl. No.: 19/570,156

(22) Filed: Mar. 18, 2026

(30) Foreign Application Priority Data
Mar. 28, 2025 (JP) 2025-055029

(51) Int. Cl. H01M 50/586; H01M 4/134; H01M 4/36; H01M 10/052; H01M 10/0562; H01M 10/0585; H01M 50/474; H01M 50/483; H01M 50/486; H01M 50/593

(52) U.S. Cl. CPC H01M 50/586; H01M 4/134; H01M 4/366; H01M 10/052; H01M 10/0562; H01M 10/0585; H01M 50/474; H01M 50/483; H01M 50/486; H01M 50/593

(57) ABSTRACT

Provided is a solid-state battery with improved safety. A negative electrode active material layer includes at least one of lithium metal or a lithium alloy. The negative electrode active material layer has an outer edge extending in directions orthogonal to the laminating direction of the laminate and covered with a first insulating member. A positive electrode active material layer has an outer edge extending in the directions orthogonal to the laminating direction of the laminate and covered with a second insulating member. In each of the directions orthogonal to the laminating direction, a length obtained by subtracting a length from a center of the laminate to an outer end of the first insulating member from a length from the center of the laminate to an outer end of the second insulating member is defined as c, and c is larger than 0 (c>0).

This application is based on and claims the benefit of priority from Japanese Patent Application No. 2025-055029, filed on 28 Mar. 2025, the content of which is incorporated herein by reference.

### BACKGROUND OF THE INVENTION

### Field of the Invention

The present invention relates to a solid-state battery and a method of manufacturing a solid-state battery.

### Related Art

In recent years, research and development of secondary batteries that contribute to energy efficiency has been carried out in order to ensure many people have access to affordable, reliable, sustainable, and advanced energy.

As the secondary batteries, solid-state batteries in which a solid electrolyte layer is disposed between a positive electrode layer and a negative electrode layer are known. As the solid-state batteries, lithium metal batteries in which a lithium metal or a lithium alloy is used as a negative electrode active material are known.

PCT International Publication No. WO 2023/057811 discloses a technique in which peripheral edges of a positive electrode active material layer and a negative electrode active material layer of a solid-state battery, such as a lithium metal battery, are covered with an elastic member, thereby making it possible to reduce the likelihood of occurrence of cracking and the like in a solid electrolyte layer even when the solid electrolyte layer is pressed during manufacturing.

Patent Document 1: PCT International Publication No. WO2023/057811.

### SUMMARY OF THE INVENTION

Incidentally, in lithium metal batteries, the lithium metal or lithium alloy may be melted under high temperature conditions. Therefore, even in the case where the lithium metal or lithium alloy is melted, it is required to minimize the risk of a short circuit due to contact with the positive electrode and to improve the safety of lithium metal batteries. As disclosed in PCT International Publication No. WO 2023/057811, it would be possible to prevent short circuits of lithium metal batteries to a certain extent by covering the peripheral edges of the positive electrode active material layer and the negative electrode active material layer. However, because molten lithium metal or lithium alloy may flow out through a minute gap, there has been a demand for a technique that enables further improvement in the safety of lithium metal batteries.

The present invention has been made in view of the above circumstances, and it is an object of the present invention to provide a solid-state battery with improved safety.
(1) A first aspect of the present invention is directed to a solid-state battery including a laminate in which a negative electrode current collector layer, a negative electrode active material layer, a solid electrolyte layer, a positive electrode active material layer, and a positive electrode current collector layer are laminated in this order in a laminating direction. The negative electrode active material layer includes at least one of lithium metal or a lithium alloy. An intermediate layer is optionally laminated between the negative electrode active material layer and the solid electrolyte layer. The negative electrode active material layer has a lamination surface covered with the solid electrolyte layer or the intermediate layer. The negative electrode active material layer has an outer edge extending in directions orthogonal to the laminating direction of the laminate and covered with a first insulating member. The positive electrode active material layer has an outer edge extending in the directions orthogonal to the laminating direction of the laminate and covered with a second insulating member. In each of the directions orthogonal to the laminating direction, a length obtained by subtracting a length from a center of the laminate to an outer end of the first insulating member from a length from the center of the laminate to an outer end of the second insulating member is defined as c, and c is larger than 0 (c>0).
(2) According to a second aspect, in the solid-state battery described in (1), in each of the directions orthogonal to the laminating direction, a length obtained by subtracting a length from the center of the laminate to an inner end of the second insulating member from a length from the center of the laminate to an inner end of the first insulating member is defined as d, and d is larger than 0 (d>0).
(3) According to a third aspect, in the solid-state battery described in (2), in each of the directions orthogonal to the laminating direction, a length of the first insulating member is defined as b, a length of the second insulating member is defined as a, and a relationship represented as a=b+c+d is satisfied.
(4) According to a fourth aspect, in the solid-state battery described in any one of (1) to (3), in each of the directions orthogonal to the laminating direction, the negative electrode active material layer has a larger length than the positive electrode active material layer.
(5) According to a fifth aspect, in the solid-state battery described in (2), in each of the directions orthogonal to the laminating direction, a length obtained by subtracting a length Lp from the center of the laminate to an outer end of the positive electrode active material layer from a length Ln from the center of the laminate to an outer end of the negative electrode active material layer is defined as Ln−Lp, and a relationship represented as d<Ln−Lp is satisfied.
(6) According to a sixth aspect, in the solid-state battery described in any one of (1) to (5), the first insulating member has a length that is equal to or larger than that of the negative electrode active material layer in the laminating direction.
(7) According to a seventh aspect, in the solid-state battery described in any one of (1) to (6), the intermediate layer is laminated between the negative electrode active material layer and the solid electrolyte layer.
(8) According to an eighth aspect, in the solid-state battery described in any one of (1) to (7), the first insulating member and the second insulating member both include a ceramic material.
(9) According to a ninth aspect, in the solid-state battery described in any one of (1) to (8), the first insulating member and the second insulating member both include alumina.
(10) According to a tenth aspect, in the solid-state battery described in any one of (1) to (9), the first insulating member and the second insulating member both include alumina and a fluorine-based resin.
(11) According to an eleventh aspect, in the solid-state battery described in any one of (1) to (10), the first insulating member and the second insulating member are composed of the same material.
(12) A twelfth aspect is directed to a method of manufacturing the solid-state battery described in any one of (1) to (11), the method including a first step including forming, by application, the first insulating member around each of a plurality of the negative electrode active material layers formed at substantially equal intervals on the negative electrode current collector layer, thereby obtaining a negative electrode layer.
(13) According to a thirteenth aspect, the method described in (12) further includes: a second step including forming the solid electrolyte layer or the intermediate layer and the solid electrolyte layer on the negative electrode layer after the first step, thereby obtaining a semifinished laminate; and a third step including cutting the semifinished laminate straight along the laminating direction after the second step.

The present invention can provide a solid-state battery with higher safety.

### BRIEF DESCRIPTION OF THE DRAWINGS

FIG. 1 is a schematic cross-sectional view illustrating a structure of a solid-state battery according to a first embodiment of the present invention;

FIG. 2 is a schematic cross-sectional view illustrating the structure of the solid-state battery according to the first embodiment of the present invention;

FIG. 3 is a diagram illustrating a method of manufacturing the solid-state battery according to the embodiment of the present invention;

FIG. 4 is a schematic cross-sectional view illustrating a structure of a solid-state battery according to a second embodiment of the present invention; and

FIG. 5 is a schematic cross-sectional view illustrating a structure of a solid-state battery according to a third embodiment of the present invention.

### DETAILED DESCRIPTION OF THE INVENTION

### First Embodiment

### Solid-State Battery

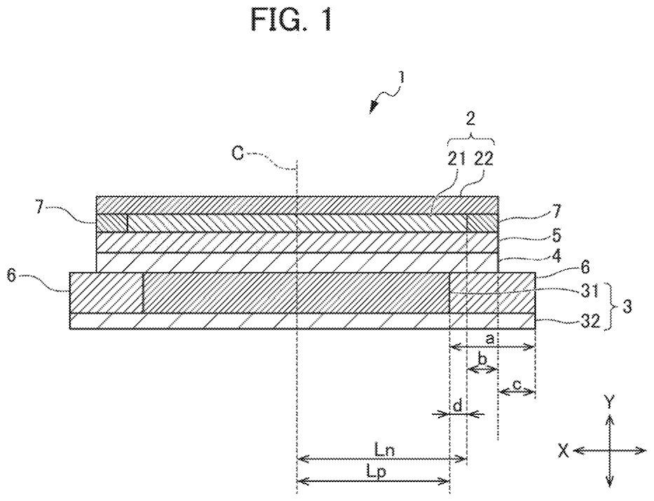

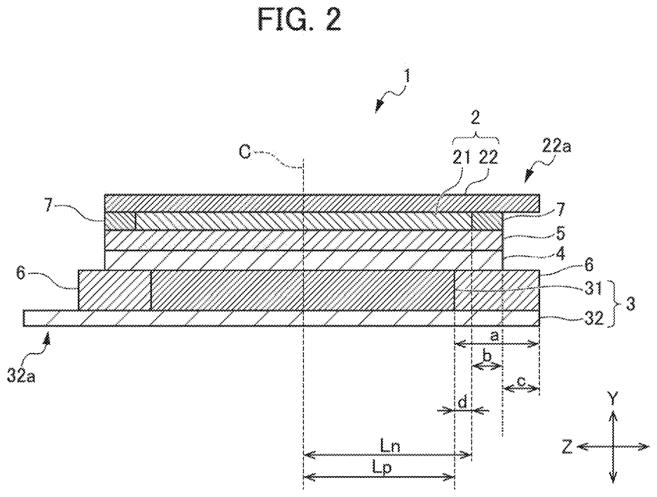

FIGS. 1 and 2 are cross-sectional views schematically illustrating a structure of a solid-state battery 1 manufactured by a method of manufacturing a solid-state battery according to a first embodiment. In the drawings, the Y direction indicates a laminating direction of layers. The Z direction indicates a direction which is orthogonal to the laminating direction and in which current collector tabs (a negative electrode tab 21a and a positive electrode tab 31a described later) extend. The X direction indicates a direction orthogonal to the Y direction and the Z direction. FIG. 1 is a schematic view illustrating a cross section of the solid-state battery 1, taken along a line orthogonal to the Z direction. FIG. 2 is a schematic view illustrating a cross section of the solid-state battery 1, taken along a line orthogonal to the X direction. The drawings to be referred to in the following description schematically illustrate respective configurations for convenience of description, and the sizes of components illustrated therein are not true to the actual sizes.

As illustrated in FIG. 1, the solid-state battery 1 includes a laminate in which a negative electrode current collector layer 22, a negative electrode active material layer 21, a solid electrolyte layer 4, a positive electrode active material layer 31, and a positive electrode current collector layer 32 are laminated in this order in the laminating direction. The negative electrode active material layer 21 has an outer edge extending in the directions orthogonal to the laminating direction and covered with a first insulating member 7. The positive electrode active material layer 31 has an outer edge extending in directions orthogonal to the laminating direction and covered with a second insulating member 6. An intermediate layer 5 may be optionally laminated between the negative electrode active material layer 21 and the solid electrolyte layer 4. The negative electrode active material layer 21 has lamination surfaces that are covered with the negative electrode current collector layer 22 and the intermediate layer 5 or the solid electrolyte layer 4, respectively. The outer edge (the entirety of the surface other than the lamination surfaces) of the negative electrode active material layer 21 is covered with the first insulating member 7. Therefore, it is preferable that the outer surfaces of the negative electrode active material layer 21 are completely covered with other layers. The solid-state battery 1 is a lithium metal secondary battery including at least one of lithium metal or a lithium alloy as a negative electrode active material. The solid-state battery 1 according to the present embodiment can satisfactorily prevent or suppress a short circuit by means of the first insulating member 7 and the second insulating member 6 even in the unlikely event that the lithium metal or lithium alloy melts.

### Negative Electrode Layer

A negative electrode layer 2 includes the negative electrode active material layer 21 and the negative electrode current collector layer 22. The negative electrode active material layer 21 contains the lithium metal or lithium alloy as the negative electrode active material. The lithium metal alloy may include any metal that can be alloyed with lithium, and the metal may be, for example, one or more metals selected from the group consisting of Sn, Ag, Mg, In, Si, Al, Bi, Sb, Zn, and Cu. The metal that can be alloyed with lithium is preferably Ag or Mg, for example, from the viewpoint of obtaining preferred battery performance (discharge characteristics) of the solid-state battery 1.

The negative electrode active material layer 21 may contain, in addition to the above, a material that can be contained in a negative electrode active material layer of a solid-state battery. Examples of the material include a solid electrolyte, a conductive additive, a binder, etc. Examples of the conductive additive include carbon black, natural graphite, carbon fibers, carbon nanotubes, etc. Examples of the solid electrolyte and the binder are the same or similar to solid electrolyte materials and binders contained in the solid electrolyte layer 4 described below.

The negative electrode current collector layer 22 may include copper, nickel, stainless steel, or the like, without any particular limitation. Examples of the shape of the negative electrode current collector layer 22 include a foil shape, a plate shape, a mesh shape, a nonwoven fabric shape, a foamed shape, etc. The negative electrode current collector layer 22 may be composed of a metal foil and a metal layer formed by plating or the like on the metal foil. A specific example includes a configuration in which nickel (Ni) plating is formed on a copper foil. A part of the negative electrode current collector layer 22 extends in the Z direction to form a negative electrode current collector tab 22a, as illustrated in FIG. 2.

### First Insulating Member

The first insulating member 7 is provided along the outer edge of the negative electrode active material layer 21 extending in the directions orthogonal to the laminating direction. The first insulating member 7 is disposed so as to cover all the surfaces of the negative electrode active material layer 21 except for the lamination surfaces. Even when the lithium metal or lithium alloy is melted under high temperature conditions, the first insulating member 7 can eliminate or reduce the likelihood that the molten lithium metal or lithium alloy flows out of the negative electrode layer 2. The first insulating member 7 functioning in this way may have, for example, a frame shape.

The first insulating member 7 may be constituted of any material, example of which include, but are not limited to, materials having insulating properties other than semiconductors and conductors. From the viewpoint of obtaining preferred heat resistance, the first insulating member 7 preferably contains a ceramic material. As the ceramic material, alumina is particularly preferred. Examples of the ceramic material other than alumina include magnesia, zirconia, titanium oxide, silicon nitride, etc. The examples of the material include, in addition to those described above, resins such as polyvinylidene fluoride (PVDF) and rubbers such as styrene-butadiene rubber (SBR).

In the case where the first insulating member 7 contains alumina, it is preferable for the first insulating member 7 to further contain a binder in addition to alumina, from the viewpoint of facilitating layer formation. The binder is not particularly limited, but it is preferable to use a fluorine-based resin from the viewpoint of enhancing the heat resistance and chemical stability of the first insulating member 7. Examples of the fluorine-based resin include polyvinylidene fluoride (PVDF), perfluoroalkoxy fluorine resin (PFA), etc. In the case where the first insulating member 7 contains alumina and a fluorine-based resin, the mass ratio of alumina to the binder (alumina:binder) is preferably 80:20 to 99:1, more preferably 90:10 to 99:1, and even more preferably 92:8 to 97:3.

### Positive Electrode Layer

A positive electrode layer 3 includes the positive electrode active material layer 31 and the positive electrode current collector layer 32. The positive electrode active material layer 31 is not particularly limited and can be constituted of a material that can be used as a positive electrode active material for a solid-state battery. Examples of the positive electrode active material constituting the positive electrode active material layer 31 include, but are not limited to, layered positive electrode active material particles such as LiCoO₂, LiNiO₂, LiCoₓNi_{y}Mn_{z}O₂ (x+y+z=1), LiVO₂, and LiCrO₂; spinel-type positive electrode active materials such as LiMn₂O₄, Li(Ni_{0.25}Mn_{0.75})₂O₄, LiCoMnO₄, and Li₂NiMn₃O₈; olivine-type positive electrode active materials such as LiCoPO₄, LiMnPO₄, and LiFePO₄; solid solution oxides (Li₂MnO₃—LiMO₂ (M=Co, Ni, etc.)); conductive polymers such as polyaniline and polypyrrole; sulfides such as Li₂S, CuS, Li—Cu—S compounds, TiS₂, FeS, MoS₂, and Li—Mo—S compounds; and mixtures of sulfur and carbon. The positive electrode active material may be constituted of one of these materials or may be composed of two or more of these materials.

The positive electrode active material layer 31 may include, in addition to the above, materials that can be contained in a positive electrode active material layer of a solid-state battery, such as a solid electrolyte, a conductive additive, a binder, etc. Examples of these materials are the same or similar to the examples of the materials that can be contained in the negative electrode active material layer 21.

The positive electrode current collector layer 32 is not particularly limited, but can be constituted of, for example, aluminum, stainless steel, conductive carbon (graphite, carbon nanotubes, etc.), and the like. Examples of the shape of the positive electrode current collector layer 32 include a foil shape, a plate shape, a mesh shape, a nonwoven fabric shape, a foamed shape, etc. A part of the positive electrode current collector layer 32 extends in the Z direction to form a positive electrode current collector tab 32a, as illustrated in FIG. 2.

### Second Insulating Member

The second insulating member 6 is provided along the outer edge of the positive electrode active material layer 31 extending in the directions orthogonal to the laminating direction. The second insulating member 6 can prevent or suppress a short circuit of the solid-state battery 1 and improve the strength. The second insulating member 6 functioning in this way may have, for example, a frame shape. The second insulating member 6 may be in contact with a part of the lamination surface of the positive electrode current collector layer 32 and have a gap through which the positive electrode current collector tab 32a extends.

Examples of a material constituting the second insulating member 6 are the same or similar to the examples of the material constituting the first insulating member 7. It is preferable that the first insulating member 7 and the second insulating member 6 both include alumina. It is preferable that the first insulating member 7 and the second insulating member 6 both include alumina and a fluorine-based resin. It is preferable that the first insulating member 7 and the second insulating member 6 are composed of the same material.

### Solid Electrolyte Layer

In the present embodiment, the solid electrolyte layer 4 is laminated between the intermediate layer 5 and the positive electrode layer 3. FIG. 1 illustrates a state in which one solid electrolyte layer 4 is laminated between the intermediate layer 5 and the positive electrode layer 3, but the number of solid electrolyte layers 4 laminated between the intermediate layer 5 and the positive electrode layer 3 is not limited to one. For example, the number of laminated solid electrolyte layers 4 may be two, or three or more. In a case where the solid-state battery 1 does not include the intermediate layer 5, the solid electrolyte layer 4 may be laminated between the negative electrode layer 2 and the positive electrode layer 3. The solid electrolyte layer 4 includes a solid electrolyte material. The solid electrolyte material is not particularly limited, and examples thereof include inorganic solid electrolytes such as sulfide solid electrolyte materials, oxide solid electrolyte materials, halide solid electrolytes, and lithium-containing salts, polymer-based solid electrolytes such as polyethylene oxide, etc. One of these solid electrolyte materials may be used alone, or two or more thereof may be used in combination.

The solid electrolyte layer 4 may include a binder in addition to the solid electrolyte material described above. Examples of the binder include fluorine-based resins, nitrile-based polymers, polyester-based polymers, acrylic acid-based polymers, cellulose-based polymers, styrene-based polymers, styrene butadiene-based polymers, vinyl acetate-based polymers, urethane-based polymers, etc. One of these binders may be used alone, or two or more thereof may be used in combination.

### Intermediate Layer

The intermediate layer 5 is optionally disposed between the negative electrode layer 2 and the solid electrolyte layer 4. The intermediate layer 5 has lithium ion conductivity. The intermediate layer 5 has a function of causing lithium metal (dendrite) to deposit uniformly. The number of intermediate layers 5 is not particularly limited.

The intermediate layer 5 may be constituted of any substance, and examples thereof include a metal that can be alloyed with lithium, amorphous carbon, etc. Examples of the metal that can be alloyed with lithium include tin (Sn), silicon (Si), zinc (Zn), magnesium (Mg), gold (Au), platinum (Pt), palladium (Pd), silver (Ag), aluminum (Al), bismuth (Bi), antimony (Sb), indium (In), etc. These metals may be composited with carbon. The metal that can be alloyed with lithium may be in the form of nanoparticles. Examples of the amorphous carbon include carbon black such as acetylene black, furnace black, Ketjhen black, and the like, coke, activated carbon, etc. The amorphous carbon may be graphitizable carbon (soft carbon), or may be non-graphitizable carbon (hard carbon), CNT (carbon nanotube), fullerene, or graphene. The intermediate layer 5 may contain a binder in addition to the above substances. As the binder, the same substance as the binder that can be contained in the solid electrolyte layer 4 can be used.

Preferred arrangements, sizes, and the like of the layers will be described below. The following description is provided with reference to FIG. 1, which is a cross-sectional view taken along a line orthogonal to the Z direction of the solid-state battery 1. A similar description can also be applied to FIG. 2, which is a cross-sectional view taken along a line orthogonal to the X direction of the solid-state battery 1. In the solid-state battery 1 of the present embodiment, the negative electrode layer 2 including the first insulating member 7, the intermediate layer 5, and the solid electrolyte layer 4 have the same length in the X direction (direction orthogonal to the laminating direction), and their end surfaces are aligned. The positive electrode layer 3 including the second insulating member 6 has a larger length than each of the foregoing layers in the X direction, and has opposite end surfaces located outward in the X direction with respect to the foregoing layers. The same applies to the lengths in the Z direction.

As illustrated in FIG. 1, in the X direction, a length obtained by subtracting a length from the center of the laminate to an outer end of the first insulating member 7 from a length from the center of the laminate to an outer end of the second insulating member 6 is defined as c, and c is larger than 0 (c>0). In other words, in the X direction, the outer end of the first insulating member 7 is located inside the laminate with respect to the outer end portion of the second insulating member 6. Due to this configuration in which c is large than 0 (c>0), the distance between the end of the negative electrode and the end of the positive electrode (creepage distance) can be increased, whereby the likelihood of a short circuit of the solid-state battery 1 can be reduced. In the process for manufacturing the solid-state battery 1, a step of cutting the layers may generate burrs on the cut surfaces of the layers. The above-described configuration makes it possible to reduce the likelihood of a short circuit of the solid-state battery 1 even in the case where burrs have been generated. In the present specification, the center of the laminate means a point on the symmetry axis C in each cross-sectional view.

When the length in the X direction of the negative electrode current collector layer 22 (excluding the length of the negative electrode current collector tab 22a; the same applies hereinafter) is defined as 100, c is preferably 0.2 or more and 2.0 or less, more preferably 0.3 or more and 1.7 or less, and further preferably 0.5 or more and 1.5 or less. In a case where c is too small, the likelihood of a short circuit of the solid-state battery 1 becomes relatively high. In a case where c is too large, the disadvantage that the energy density of the solid-state battery 1 decreases outweighs the effect of improving the safety of the solid-state battery 1.

The length in the X direction of the negative electrode active material layer 21 is preferably larger than the length in the X direction of the positive electrode active material layer 31. This configuration makes it possible to increase the capacity of the negative electrode and improve the energy density of the solid-state battery 1.

In the X direction, a length obtained by subtracting a length from the center of the laminate to an inner end of the second insulating member 6 from a length from the center of the laminate to an inner end of the first insulating member 7 is defined as d, and it is preferable that d is larger than 0 (d>0). As described above, it is preferable that the length in the X direction of the negative electrode active material layer 21 is larger than the length in the X direction of the positive electrode active material layer 31. To satisfy this preferred condition, d needs to be larger than 0 (d>0). If d is less than 0 (d<0) and an end in the X direction of the positive electrode active material layer 31 is positioned closer to the outside of the laminate than an end in the X direction of the negative electrode active material layer 21, the likelihood of a short circuit of the solid-state battery 1 is higher than in the case where d is larger than 0 (d>0). Specifically, in the case where d is less than 0 (d<0), Li dendrites are likely to be generated at ends of the lithium metal or lithium alloy constituting the negative electrode active material layer 21 during charge of the solid-state battery 1, which increases the likelihood of a short circuit. Therefore, setting d to be larger than 0 (d>0) makes it possible to reduce the likelihood of a short circuit of the solid-state battery 1.

When the length in the X direction of the negative electrode current collector layer 22 is defined as 100, d is preferably 0.1 or more and 3.0 or less, and more preferably 0.5 or more and 2.0 or less. In a case where d is too small, the likelihood of a short circuit of the solid-state battery 1 becomes relatively high as described above. In a case where d is too large, on condition that the positive electrode active material layer 31 is unchanged in size, a situation may arise in which the length b in the X direction of the first insulating member 7 or the length c cannot be sufficiently ensured. In such a case, the likelihood of a short circuit of the solid-state battery 1 becomes relatively high. In order to avoid the above situation, it is conceivable to increase a length denoted by a, for example, but in that case, the energy density of the solid-state battery 1 decreases.

In the X direction, a length obtained by subtracting a length Lp from the center of the laminate to an outer end of the positive electrode active material layer 31 from a length Ln from the center of the laminate to an outer end of the negative electrode active material layer 21 is defined as Ln−Lp, and it is preferable that a relationship represented as d <Ln−Lp is satisfied. This makes it possible to reduce the likelihood of a short circuit of the solid-state battery 1 and improve the energy density of the solid-state battery 1.

In a case where the length in the X direction of the first insulating member 7 (the length in the X direction of the first insulating member 7 shown on one end side in FIG. 1) is defined as b and the length in the X direction of the second insulating member 6 (the length in the X direction of the second insulating member 6 shown on the one end side in FIG. 1) is defined as a, it is preferable that a relationship expressed as a=b+c+d is satisfied. When this relationship is satisfied, the arrangement of the layers satisfying c>0 can be satisfactorily achieved, the likelihood of a short circuit of the solid-state battery 1 can be satisfactorily reduced, and the energy density of the solid-state battery 1 can be improved.

From the viewpoint of reducing the likelihood of a short circuit of the solid-state battery 1, the length b in the X direction of the first insulating member 7 is preferably 0.5 or more with respect to the length in the X direction of the negative electrode current collector layer 22 defined as 100. From the viewpoint of energy density, the upper limit may be 2.0 or less, for example, although it is not particularly limited thereto.

It is preferable that the first insulating member 7 has a length that is equal to or larger than the length of the negative electrode active material layer 21 in the Y direction (laminating direction). This configuration makes it possible to suppress leakage of the molten lithium metal or lithium alloy to the outside.

### Method of Manufacturing Solid-State Battery

A method of manufacturing the solid-state battery 1 according to the present embodiment will be described below as an example. The method of manufacturing the solid-state battery according to the present embodiment includes a first step of forming, by application, the first insulating member 7 around each of the negative electrode active material layers 21 formed at substantially equal intervals on the negative electrode current collector layer 22, thereby obtaining the negative electrode layer. Furthermore, the method preferably includes, after the first step, a second step of forming the solid electrolyte layer 4 or the intermediate layer 5 and the solid electrolyte layer 4 on the negative electrode active material layers 21, thereby obtaining a laminate, and a third step of cutting the laminate straight along the laminating direction after the second step.

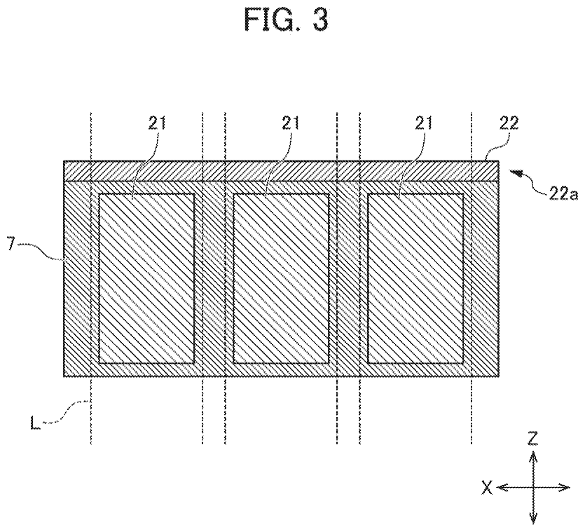

FIG. 3 is a diagram schematically illustrating the method of manufacturing the solid-state battery 1 according to the present embodiment. Specifically, FIG. 3 illustrates the negative electrode layer 2 in the course of the method, as viewed in the laminating direction. The method of manufacturing the solid-state battery 1 according to the present embodiment is, for example, a method of manufacturing a plurality of the negative electrode layers 2 on a manufacturing line. In the first step, the first insulating member 7 is formed by application around each of the negative electrode active material layers 21 formed at substantially equal intervals on the negative electrode current collector layer 22. This step makes it easy to form the first insulating member 7 in close contact with the periphery of each of the negative electrode active material layers 21, and makes it easy to make the negative electrode active material layers 21 and the first insulating members 7 have the same length in the laminating direction. In the first step, for example, a composition for forming the first insulating member 7 is applied around each of the negative electrode active material layers 21 except for the locations for the negative electrode current collector tabs 22a, and then cured by drying or the like.

In the second step, the intermediate layer 5 is optionally formed on the negative electrode layer 2, and the solid electrolyte layer 4 is further formed, thereby forming a semifinished laminate. An example of the method of forming the intermediate layer 5 and the solid electrolyte layer 4 includes preparing a slurry by dispersing a material constituting each layer in a solvent, applying the slurry to predetermined locations, and then drying the slurry. Instead of this method, the layers each formed on a transfer sheet may be transferred.

In the third step, the semifinished laminate obtained in the second step is cut straight along the Y direction, for example, along the cutting lines L in FIG. 3, into a predetermined size. As a result, the end surfaces of the semifinished laminate can be made uniform. Therefore, manufacturing variations are reduced and quality is improved.

The method of manufacturing the solid-state battery 1 may include any known step for manufacturing a solid-state battery, in addition to or instead of the steps described above.

The first embodiment of the present invention has been described above. Other embodiments of the present invention will be described below. Components that are the same or similar to those of the first embodiment are denoted by the same reference signs in the drawings and descriptions thereof are omitted.

### Second Embodiment

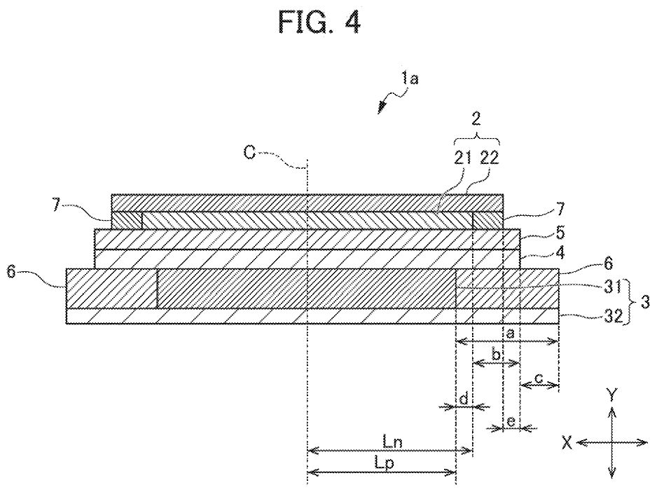

FIG. 4 is a schematic diagram corresponding to FIG. 1 and illustrates a configuration of a solid-state battery 1a according to a second embodiment. In the solid-state battery 1a, the negative electrode layer 2 including the first insulating member 7 has the smallest length in a direction (X direction) orthogonal to the laminating direction. The intermediate layer 5 and the solid electrolyte layer 4 have the same length in the X direction, and their end surfaces are aligned. The positive electrode layer 3 including the second insulating member 6 has a larger length than each of the foregoing layers in the X direction, and has opposite end surfaces located outward with respect to the foregoing layers. The same applies to the lengths in the Z direction.

The solid-state battery 1a is obtained by laminating the solid electrolyte layer 4 and the intermediate layer 5 in this order on the positive electrode layer 3 including the second insulating member 6, and finally laminating the negative electrode layer 2 including the first insulating member 7 over the foregoing layers. Therefore, a stepped portion may be formed between the negative electrode layer 2 including the first insulating member 7 and the solid electrolyte layer 4 and the intermediate layer 5. Specifically, a length obtained by subtracting a length from the center of the laminate to an outer end of the first insulating member 7 from a length from the center of the laminate to outer ends of the solid electrolyte layer 4 and the intermediate layer 5 is defined as e, and e is equal to or larger than 0 (e≥0). In this case as well, it is preferable to design the components similarly to those of the solid-state battery 1 according to the first embodiment described above, but it is preferable that a relationship expressed as a=b+c+d+e is satisfied. When this relationship is satisfied, the arrangement of the layers satisfying c>0 can be satisfactorily achieved.

The method of manufacturing the solid-state battery 1a does not include the above-described second step because the negative electrode layer 2 is separately produced as described above, and in the third step, only the negative electrode layer 2 is cut straight along the Y direction into a predetermined size. The intermediate layer 5 is laminated on the solid electrolyte layer 4, and these laminated layers are cut straight along the Y direction so that their end surfaces are aligned. Thereafter, the laminate of the solid electrolyte layer 4 and the intermediate layer 5 is laminated on the positive electrode layer 3, and finally the negative electrode layer 2 is laminated on a side of the intermediate layer 5. The rest of the manufacturing method is the same as that of the first embodiment.

### Third Embodiment

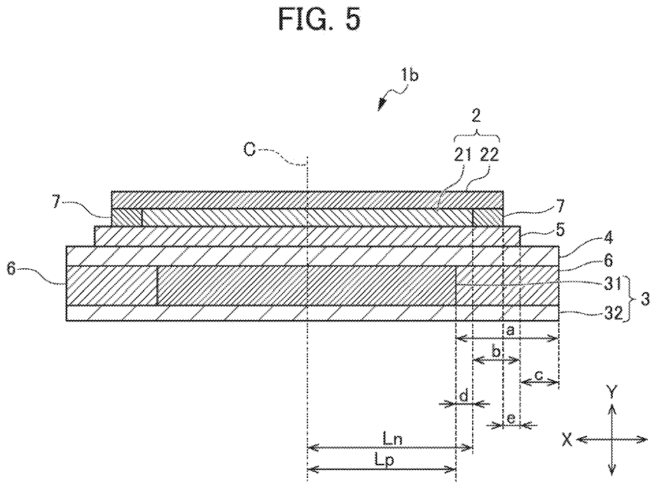

FIG. 5 is a schematic diagram corresponding to FIG. 1 and illustrates a configuration of a solid-state battery 1b according to a third embodiment. In the solid-state battery 1b, the negative electrode layer 2 including the first insulating member 7 has the smallest length in a direction (X direction) orthogonal to the laminating direction. The intermediate layer 5 has a larger length than the length of the negative electrode layer 2 in the X direction. The solid electrolyte layer 4 and the positive electrode layer 3 including the second insulating member 6 have the same length in the X direction, and their end surfaces are aligned. The solid electrolyte layer 4 and the positive electrode layer 3 including the second insulating member 6 have a larger length than the foregoing layers in the X direction, and have opposite end surfaces located outward with respect to the foregoing layers. The same applies to the lengths in the Z direction.

Similarly to the solid-state battery 1a, the solid-state battery 1b is obtained by laminating the solid electrolyte layer 4 and the intermediate layer 5 in this order on the positive electrode layer 3 including the second insulating member 6, and finally laminating the negative electrode layer 2 including the first insulating member 7 over the foregoing layers. Therefore, a stepped portion may be formed between the negative electrode layer 2 including the first insulating member 7 and the intermediate layer 5. Specifically, a length obtained by subtracting a length from the center of the laminate to an outer end of the first insulating member 7 from a length from the center of the laminate to an outer end of the intermediate layer 5 is defined as e, and e is equal to or larger than 0 (e≥0). In this case as well, it is preferable to design the components similarly to those of the solid-state battery 1 according to the first embodiment described above, but it is preferable that a relationship expressed as a=b+c+d+e is satisfied. When this relationship is satisfied, the arrangement of the layers satisfying c>0 can be satisfactorily achieved.

A method of manufacturing the solid-state battery 1b does not include the above-described second step because the negative electrode layer 2 is separately produced as described above, and in the third step, only the negative electrode layer 2 is cut straight along the Y direction into a predetermined size. The solid electrolyte layer 4 is laminated on the positive electrode layer 3, and these laminated layers are cut straight along the Y direction so that their end surfaces are aligned. Thereafter, the intermediate layer 5 is further laminated on a side of the solid electrolyte layer 4, and finally the negative electrode layer 2 is laminated on a side of the intermediate layer 5. The rest of the manufacturing method is the same as that of the first embodiment.

The preferred embodiments of the present invention have been described above. The present invention is not limited to the above-described embodiments, and can be appropriately modified within a range where the effects of the present invention are not impaired.

### Explanation of Reference Numerals

1: Solid-state battery
2: Negative electrode layer
22: Negative electrode current collector layer
3: Positive electrode layer
31: Positive electrode active material layer
32: Positive electrode current collector layer
4: Solid electrolyte layer
5: Intermediate layer
6: Second insulating member
7: First insulating member

What is claimed is:

1. A solid-state battery comprising:
a laminate in which a negative electrode current collector layer, a negative electrode active material layer, a solid electrolyte layer, a positive electrode active material layer, and a positive electrode current collector layer are laminated in this order in a laminating direction,
the negative electrode active material layer comprising at least one of lithium metal or a lithium alloy, wherein
an intermediate layer is optionally laminated between the negative electrode active material layer and the solid electrolyte layer,
the negative electrode active material layer has a lamination surface covered with the solid electrolyte layer or the intermediate layer,
the negative electrode active material layer has an outer edge extending in directions orthogonal to the laminating direction of the laminate and covered with a first insulating member,
the positive electrode active material layer has an outer edge extending in the directions orthogonal to the laminating direction of the laminate and covered with a second insulating member,
in each of the directions orthogonal to the laminating direction, a length obtained by subtracting a length from a center of the laminate to an outer end of the first insulating member from a length from the center of the laminate to an outer end of the second insulating member is defined as c, and c is larger than 0 (c>0).

2. The solid-state battery according to claim 1, wherein in each of the directions orthogonal to the laminating direction, a length obtained by subtracting a length from the center of the laminate to an inner end of the second insulating member from a length from the center of the laminate to an inner end of the first insulating member is defined as d, and d is larger than 0 (d>0).

3. The solid-state battery according to claim 2, wherein in each of the directions orthogonal to the laminating direction, a length of the first insulating member is defined as b, a length of the second insulating member is defined as a, and a relationship represented as a=b+c+d is satisfied.

4. The solid-state battery according to claim 1, wherein in each of the directions orthogonal to the laminating direction, the negative electrode active material layer has a larger length than the positive electrode active material layer.

5. The solid-state battery according to claim 2, wherein in each of the directions orthogonal to the laminating direction, a length obtained by subtracting a length Lp from the center of the laminate to an outer end of the positive electrode active material layer from a length Ln from the center of the laminate to an outer end of the negative electrode active material layer is defined as Ln−Lp, and a relationship represented as d<Ln−Lp is satisfied.

6. The solid-state battery according to claim 1, wherein the first insulating member has a length that is equal to or larger than that of the negative electrode active material layer in the laminating direction.

7. The solid-state battery according to claim 1, wherein the intermediate layer is laminated between the negative electrode active material layer and the solid electrolyte layer.

8. The solid-state battery according to claim 1, wherein the first insulating member and the second insulating member both comprise a ceramic material.

9. The solid-state battery according to claim 1, wherein the first insulating member and the second insulating member both comprise alumina.

10. The solid-state battery according to claim 1, wherein the first insulating member and the second insulating member both comprise alumina and a fluorine-based resin.

11. The solid-state battery according to claim 1, wherein the first insulating member and the second insulating member are composed of the same material.

12. A method of manufacturing the solid-state battery according to claim 1, the method comprising:
a first step including forming, by application, the first insulating member around each of a plurality of the negative electrode active material layers formed at substantially equal intervals on the negative electrode current collector layer, thereby obtaining a negative electrode layer.

13. The method according to claim 12, further comprising:
a second step including forming the solid electrolyte layer or the intermediate layer and the solid electrolyte layer on the negative electrode layer after the first step, thereby obtaining a semifinished laminate; and
a third step including cutting the semifinished laminate straight along the laminating direction after the second step.
